(19) United States
(12) Patent Application Publication
(10) Pub. No.: US 2019/0381624 A1
(43) Pub. Date: Dec. 19, 2019

(54) CHARACTERIZING A CUTTING TOOL EDGE

(71) Applicant: Element Six (UK) Limited, Oxfordshire (GB)

(72) Inventors: Frank SCHOOFS, Oxfordshire (GB); Christopher Graham, Oxfordshire (GB)

(21) Appl. No.: 16/480,357

(22) PCT Filed: Feb. 14, 2018
(86) PCT No.: PCT/EP2018/053617

§ 371 Date: Jul. 24, 2019

(30) Foreign Application Priority Data
Feb. 16, 2017 (GB) 1702554.5

(51) Int. Cl. B23Q 17/24; B23Q 17/09; G01B 11/255; G01B 15/04; G06T 7/00; G06T 7/13; G06T 7/136; G06T 7/64

(52) U.S. Cl. CPC B23Q 17/2457; B23Q 17/0919; G01B 11/255; G01B 15/04; G06T 7/0004; G06T 2207/30164; G06T 7/136; G06T 7/64; B23Q 2717/00; G06T 2207/10061; G06T 7/13

(57) ABSTRACT

A method and apparatus for characterizing a cutting tool edge from an image of the cutting tool edge. Chips, cracks and other tool edge defects are measured, providing an indication of the condition of a cutting tool edge.

### FIELD

The invention relates to the field of characterizing cutting tool edges.

### BACKGROUND

Polycrystalline super hard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials.

Abrasive compacts are used extensively in cutting, milling, grinding, drilling and other abrasive operations. They generally contain ultrahard abrasive particles dispersed in a second phase matrix. The matrix may be metallic or ceramic or a cermet. The ultrahard abrasive particles may be diamond, cubic boron nitride (cBN), silicon carbide or silicon nitride and the like. These particles may be bonded to each other during the high pressure and high temperature compact manufacturing process generally used, forming a polycrystalline mass, or may be bonded via the matrix of second phase material(s) to form a sintered polycrystalline body. Such bodies are generally known as polycrystalline diamond or polycrystalline cubic boron nitride, where they contain diamond or cBN as the ultra-hard abrasive, respectively.

During production of PCBN tool inserts, over 50% of the cost is associated with grinding. After this forming step, over 10% of the tools made up of a low content cBN grade fail due to edge chipping. The quality control is usually done visually, which is limited by the size of chips that can be seen, and is subjective (one operator may find a small chip to be acceptable, another operator may find the same chip to be unacceptable).

Alternatively, cutting edge chips can be characterized using a microscope with high magnification or an electron microscope, as shown in FIG. 1. A cutting tool edge 1 is imaged in a microscope and a chip 2 is observed. In order to characterize the chip, a first tangent 3 is drawn over the chip 2 where the unchipped edge would otherwise be seen. A second, parallel tangent 4 is drawn at the deepest point of the chip 2. The distance between the first tangent 3 and the second tangent 4 is used to estimate the depth of the chip. This is a manual process that only analyses one chip at a time, relies on subjective operator input and takes several minutes to characterize a single chip.

### SUMMARY

It is an object to provide an improved method and apparatus for characterizing a cutting edge of a tool, and in particular to characterize one or more chips or other geometrical defects in the cutting edge of the tool.

According to a first aspect, there is provided a method of characterizing a cutting tool edge. The method comprises obtaining an image of the cutting tool edge. The cutting tool edge is located in the image. A centre-point of the cutting tool edge is determined the cutting tool edge is characterized by determining the distance from the centre point to the located cutting tool edge at a plurality of angles. An advantage of this method is that all visible defects can be identified and accurately characterized with respect to their geometry and dimensions.

Exemplary ways of locating the cutting tool edge include thresholding the image and applying a Canny edge detection algorithm.

As an option, the step of determining the centre-point of the cutting tool edge includes determining a centre-point of a radius of curvature of a curved portion of the cutting tool edge. As a further option, the curved portion is substantially circular.

As a further option, the method includes the steps of:
(i) identifying first and second linear portions of the cutting tool edge located either side of the curved portion of the cutting tool edge;
(ii) determining the angle of each of the first and second linear portions relative to a y direction in the image;
(iii) if the angles of the first and second linear portions are not equivalent, rotating the image; and
(iv) repeating steps (ii) and (iii) until the angles of the first and second linear portion are equivalent.

As a further option, the method includes the steps of determining the centre-point of the radius of curvature of the curved portion of the cutting tool edge by:
extrapolating the linear portions until they intersect to determine a centre line on which the centre point is located, and
interpolating a parabola in a region around the cutting tool edge to determine the cutting tool radius of curvature.

The method optionally includes calculating the difference between the distance from the centre point to the located cutting tool edge and the distance from the centre point to the curved portion of the cutting tool edge determined by the radius of curvature. As a further option, the calculated difference is plotted against the angle relative to a central axis.

As an option, at least one correction is applied to the position of the located cutting tool edge to correct for any of a chamfer angle and a jig angle.

The image of the cutting tool edge is optionally obtained using any of an optical microscope, a scanning electron microscope, and a focus stacking imaging technique.

The cutting tool optionally comprises any of polycrystalline cubic boron nitride, polycrystalline diamond, cemented tungsten carbide, tool steel, single crystal diamond, diamond grains and cubic boron nitride grains.

According to a second aspect, there is provided a computer apparatus configured to perform characterization of a cutting tool edge. The computer apparatus is provided with an image input device arranged to obtain an image of the cutting tool edge. A processor is configured to locate the cutting tool edge in the image. The processor is further configured to determine a centre-point of the cutting tool edge. The processor is further configured to, at a plurality of angles from the centre-point, characterize the cutting tool edge by determining the distance from the centre point to the located cutting tool edge.

As an option, the processor is configured to locate the cutting tool edge by any of thresholding the image, and applying a Canny edge detection algorithm.

As an option, the processor is configured to determine a centre-point of the cutting tool edge by determining a centre-point of a radius of curvature of a curved portion of the cutting tool edge.

As a further option, the processor is further configured to perform the steps of:
(i) identifying first and second linear portions of the cutting tool edge located either side of the curved portion of the cutting tool edge;
(ii) determining the angle of each of the first and second linear portions relative to a y direction in the image;
(iii) if the angles of the first and second linear portions are not equivalent, rotating the image; and
(iv) repeating steps (ii) and (iii) until the angles of the first and second linear portion are substantially equivalent.

As a further option, the processor is further arranged to determine the centre-point of the radius of curvature of the curved portion of the cutting tool edge by extrapolating the linear portions until they intersect to determine a centre line on which the centre point is located, and interpolating a parabola in a region around the cutting tool edge to determine the cutting tool radius of curvature.

As a further option, the processor is further configured to calculate the difference between the distance from the centre point to the located cutting tool edge and the distance from the centre point to the curved portion of the cutting tool edge determine by the radius of curvature.

As a further option, the processor is further configured to plot the calculated difference against the angle relative to a central axis, the computer apparatus further comprising and output device configured to output the plot.

As an option, the processor is configured to apply at least one correction to the position of the located cutting tool edge to correct for any of a chamfer angle and a jig angle.

According to a third aspect, there is provided a computer program comprising computer readable code which, when run on a computer apparatus, causes the computer apparatus to perform the method as described above in the first aspect.

According to a fourth aspect, there is provided a computer program product comprising a computer readable medium and a computer program as described above in the third aspect, wherein the computer program is stored on the computer readable medium.

### BRIEF DESCRIPTION OF THE DRAWINGS

Non-limiting embodiments will now be described by way of example and with reference to the accompanying drawings in which:

FIG. 1 illustrates a known technique for measuring the depth of a chip observed on a cutting tool edge;

FIG. 2 illustrates an exemplary cutting tool edge;

FIG. 3 is a plot of the co-ordinates of an exemplary cutting tool edge;

FIG. 4 illustrates the cutting tool edge of FIG. 2 and further illustrates techniques for finding a central axis and centre point of a radius of curvature for the cutting tool edge;

FIG. 5 is a plot showing the angle from the centre point of the curve of the cutting tool edge 5 and the distance r at a plurality of angular positions;

FIG. 6 is a graph showing the data of FIG. 5 presented as a linear plot of variation in distance against angle from the centre point of the curve of the cutting tool edge;

FIG. 7 is a flow diagram showing exemplary steps of a method for characterising the cutting tool edge; and

FIG. 8 illustrates schematically in a block diagram an apparatus for characterizing the cutting tool edge.

### DETAILED DESCRIPTION

The inventors have established a completely different method of characterizing a cutting tool edge, which includes characterizing data for any chips or other surface defects at the cutting tool edge.

As shown in FIG. 2 herein, a plan view image is obtained of the cutting tool edge 5. In the image of FIG. 2, a darker area 6 and a lighter area 7 are shown. In a side elevation view (not shown) the cutting tool edge is chamfered, and the dark area 6 shows the chamfered portion. A small chip 8 caused during the grinding process is shown in the cutting tool edge 5.

It is important for the image to have an adequate light/dark transition from the cutting tool edge 5 to the surrounding area, with sufficient contrast, depth of field, angles etc. A drawback of taking an image using an optical microscope is the limited depth of field at higher magnifications. Some optical microscopes allow focus stacked images to be obtained, which allows the image to be focused at all depths of field at high magnification, revealing the edge chipping in detail. Acquisition settings data can be saved, so the same settings can be used for capturing subsequent images, improving the consistency of the analysis.

A back illuminated light against a relatively low top light gives the ideal contrast of the cutting tool edge 5 for the image analysis.

Note that any suitable imaging technique can be used, including optical microscopy and scanning electron microscopy.

Once the image has been obtained, the next step in the process is to extract the coordinates (in pixel space) of the cutting tool edge 5 from the image. An exemplary way of doing this is to analyse the image for a simple black/white transition, but other edge detection techniques may be used, such as Canny edge detection. This is achieved by thresholding the image; all pixels having a brightness above a certain threshold are converted to white, all pixels having a brightness at or below a certain threshold are converted to black. This is why a sharp, high contrast image is beneficial to start with.

As images may have different brightness and saturation, some operator input may be allowed in order to ensure that when the image is thresholded, it most accurately reflects the location of the cutting tool edge 5.

Thresholding provides an electronic file containing a true/false (white/black) value for each pixel in the image. An exemplary way to find the edge trace is to run along each row or column and to find a pixel transition from white/black to black/white, depending on what the starting point was. This technique is, however, susceptible to thresholding noise (e.g. where the background is not uniform) and relatively slow.

An alternative and preferred technique is to use a single line scan to find an initial point on the edge where black transitions to white, and then searching either side of this point in the vicinity of the initial point. This relies on the fact that the cutting tool edge 5 is expected to be more or less continuous in the thresholded image. The search range is within 10 pixels of the previous line and is increased in increments of 10 pixels if no transition is found. This means noise away from the edge is not picked up by the tracing algorithm.

A Boolean flag may be used to indicate whether the search should occur from the top to the bottom, bottom to top, left to right or right to left of the image, i.e. in which direction the transition at the cutting tool edge 5 is the most distinct. The image data and other relevant inputs are altered accordingly.

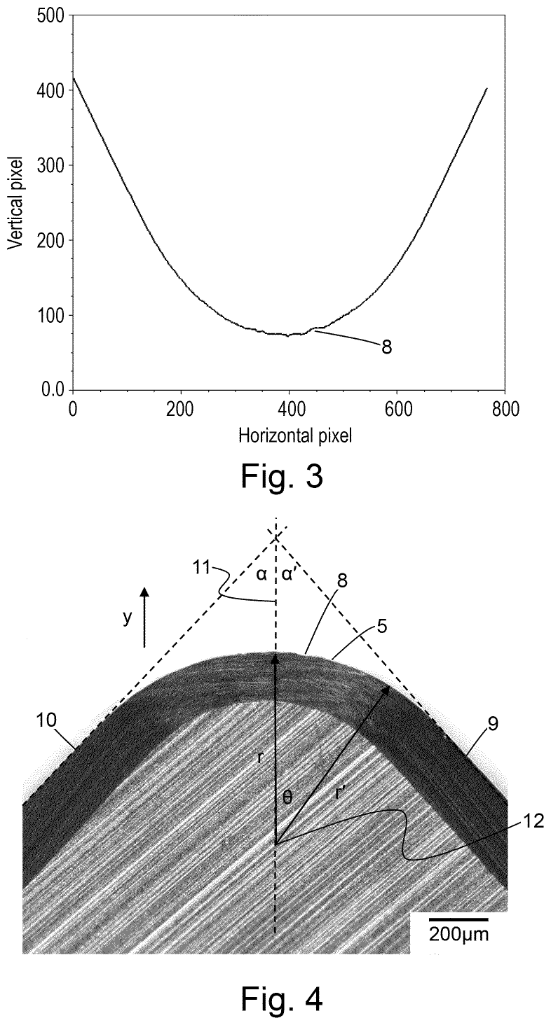

This technique is repeated as new points of the cutting tool edge 5 are found. The result of this process is that the (x, y) coordinates of the cutting tool edge 5 can be found and plotted, as shown in FIG. 3, which plots the located of the cutting tool edge 5 in terms of the pixels in the x direction and the y direction in the image.

Once the cutting tool edge 5 co-ordinates have been obtained, some image processing is required. The (x, y) co-ordinates are converted to polar co-ordinates (r, θ) with a centre of a curvature of the cutting tool edge 5 as the origin. Post-processing of the data is required to find the centre of curvature of the cutting tool edge 5. Note that the following description assumes that the curved portion of the cutting tool edge 5 has a circular geometry, but it is possible for other geometries to be used.

In order to find the centre point of curvature of the cutting tool edge 5 it is necessary to correct any rotation of the cutting tool in the image. It is difficult to position the cutting tool flush in the microscope viewing window and therefore it may be rotated with respect to the image frame. In order to facilitate the centre point search, the image is rotated in (x, y) space.

Referring to FIG. 4 herein, note that the flanks 9, 10 on either side of the nose radius are straight and of equivalent angle with respect to a central axis 10. This information can be used to correct for the rotation of the cutting tool. User input may be required to determine a vertical section of the image where the straight flanks 9, 10 are located and visible in the image. Linear regression of these points, on the upper and lower flank, provides a value for the angles α, α′ of the straight flanks 9, 10 and thus angle of these flanks with respect to y-direction of the image. If the angles α, α′ are not the equivalent, the image is rotated around the origin until the angles α, α′ are equivalent.

The direction of rotation depends on the relative magnitude and whether the nose is pointing up or down in the image.

Note the above step need not be carried out if the flanks are not visible, but correcting the rotation improves the accuracy of the subsequent analysis.

Once image rotation has been corrected, extrapolating the lines the straight flanks 9, 10 gives the central axis 11 of the cutting tool edge at the intersection of the extrapolated lines. It is possible instead for a user to visually determine and mark the central axis 11 of the cutting tool edge, but this has been found to be less accurate.

The centre point 12 of the curvature of the cutting tool edge is determined using trigonometry: the cosine of the angle between the two radii r, r′ (half the angle between the two flanks as calculated when finding the central axis 11) is equal to the radius divided by the distance from the intersection point to the centre 12. The latter distance is made up of the radius r and the distance from intersection point to the located cutting tool edge 5.

In order to determine the distance to the edge, a parabola can be interpolated in a region around the x value and the y coordinate is calculated. This also produces a value for the (calculated) tool radius r. As mentioned above, note that this technique can be extended to other, non-circular tool geometries. Also note that other techniques may be used in order to determine the distance to the cutting tool edge 5, such as applying a spline function.

The (x, y) pixel coordinates with the image-origin can now be transformed to (r, θ) coordinates with the origin in the centre of curvature 12 of the cutting tool edge 5. The distance can be converted using a user-defined image scale, determined with a graticule.

The user may define an “area of interest” for study, which is an angular range defined by the user as the region of the cutting tool edge 5 in which chips (or other surface features) need to be studied. The data are trimmed accordingly. Additionally, the image is a two-dimensional plan projection of the cutting tool edge, hence corrections may be made for the jig used to hold the tool while the image was obtained, and chamfer angles. A chamfer angle or hone on the tool, or if the image was taken at an angle such that the tool edge with the chip is not parallel to imaging plane, requires such a correction. In order to normalise the data, the calculated tool radius is subtracted as a baseline. For visualisation purposes the data may be inverted so that an edge chip (less material, lower r value) appears as a positive value.

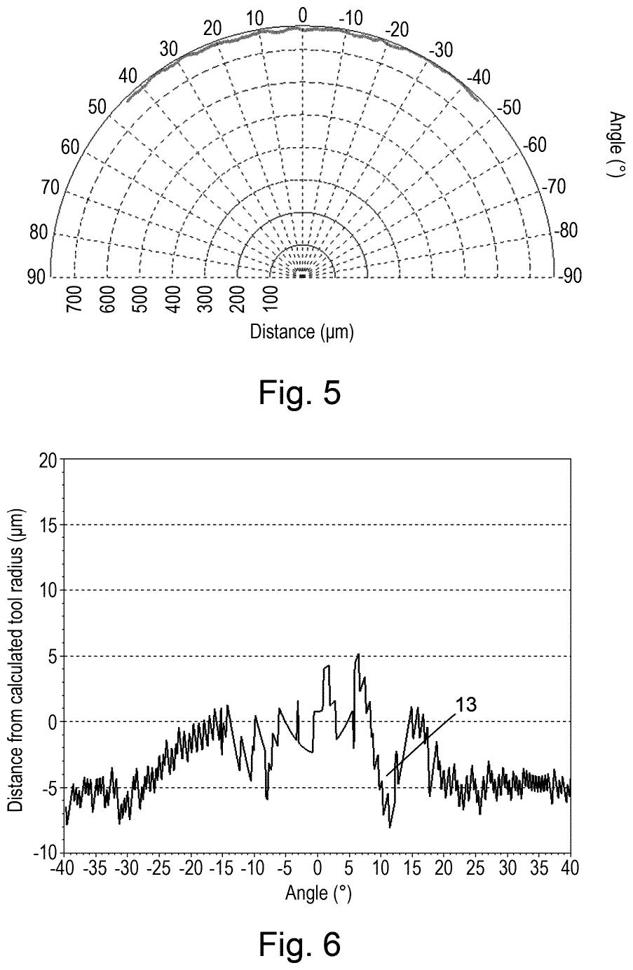

FIG. 5 is a plot showing the angle from the centre point of the curve of the cutting tool edge 5 and the distance r at a plurality of angular positions.

FIG. 6 is the same data presented as a linear plot of variation in distance against angle from the centre point of the curve of the cutting tool edge 5. In this example, the distance is presented as a difference between the distance from the centre point to the located cutting tool edge and the distance from the centre point to the curved portion of the cutting tool edge determine by the radius of curvature. Chip 8 appears as a trough 13 in the trace. Distance 0 is a normalized centre-point. At angles approaching −40° and 40° the difference tends towards the negative either because the assumption of a circular geometry does not quite apply at these angles, or there were errors in determining the centre point.

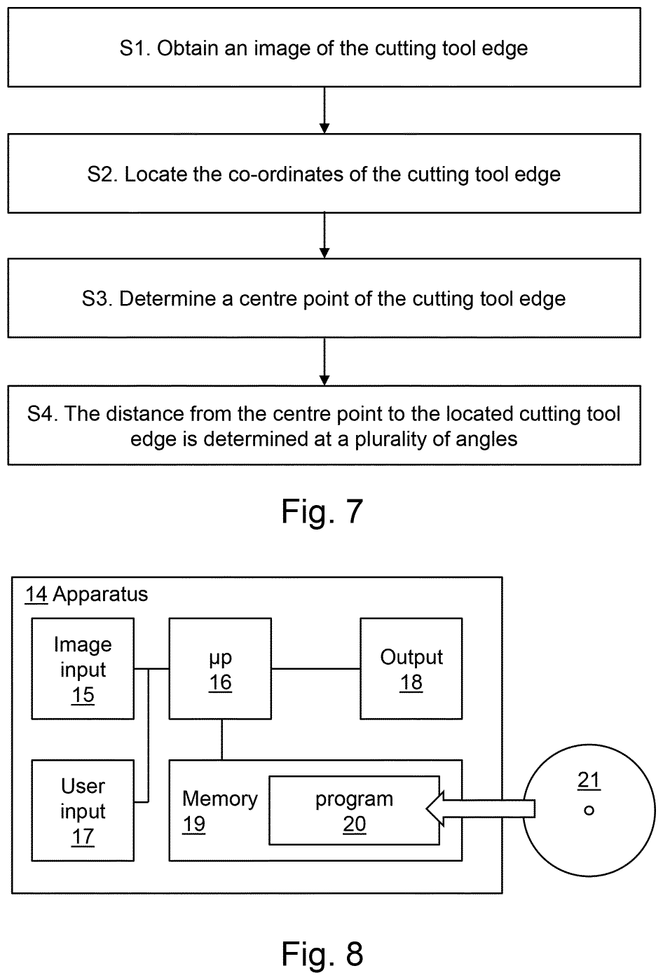

FIG. 7 is a flow diagram showing exemplary steps. The following numbering corresponds to that of FIG. 7.

S1. An image of the cutting tool is obtained. As described above, the image is preferably high contrast.

S2. The actual edge of the cutting tool is located in the image, for example by thresholding. This may be, for example, by converting the image to black and white, and may involve some user input depending on the brightness and saturation of the image.

S3. A centre-point of the cutting tool edge is determined, for example by determining the centre point of a curvature of a curved portion of the cutting tool edge 5. As described above, this may be achieved by identifying linear portions either side of the curved portion of the cutting tool edge 5, determining the angle of those portions, if necessary correcting the rotation of the image, and obtaining a central axis at the intersection of the linear portions. The centre point of the curvature of the cutting tool edge 5 may be found using trigonometry as described above.

S4. At a plurality of angles from the centre-point, the distance from the centre point to the located cutting tool edge is determined. This information may be presented simply as the distance, or as the difference between the distance from the centre point to the located cutting tool edge and the distance from the centre point to the curved portion of the cutting tool edge determine by the radius of curvature, or as the difference between the distance from the centre point to the located cutting tool edge and a normalized distance. This may further require applying at least one correction to the position of the located cutting tool edge to correct for any of a chamfer angle and a jig angle.

Turning now to FIG. 8, there is illustrated schematically in a block diagram an exemplary computer apparatus 14. The computer apparatus has an image input device 15 for obtaining an image of the cutting tool edge 5. This may be, for example, an interface connecting to a microscope. Alternatively, it may be a device for obtaining an image from another source. A processor 16 is provided for carrying out steps S1 to S4 shown in FIG. 7. A user input device 17 is also provided that allows a user to interact with the computer apparatus. This is used to allow the user to select and image, identify straight flanks, set threshold values and so on. The user input device 17 may be a combination of standard input devices, such as a keyboard, a touchscreen, a mouse and so on. An output device 18 is provided to allow the computer apparatus 14 to output information such as plots as shown in FIG. 6. Any suitable output device may be used, such as an interface to a screen or a printer.

Note that only one processor 16 is described for simplicity, but the skilled person will appreciate that more than one processor may be used. Similarly, other components such as the memory may be split as separate physical memories or may be distributed.

A computer readable medium in the form of a memory 19 is provided. This may be used to store a computer programme 20 which, when executed by the processor 16, causes the processor to perform the steps described above. Note that the computer programme may alternatively be stored on an external memory 21 which can be provided to the computer apparatus. Examples of the external memory include a CD-ROM, DVD-ROM, USB memory stick, memory card or carrier wave.

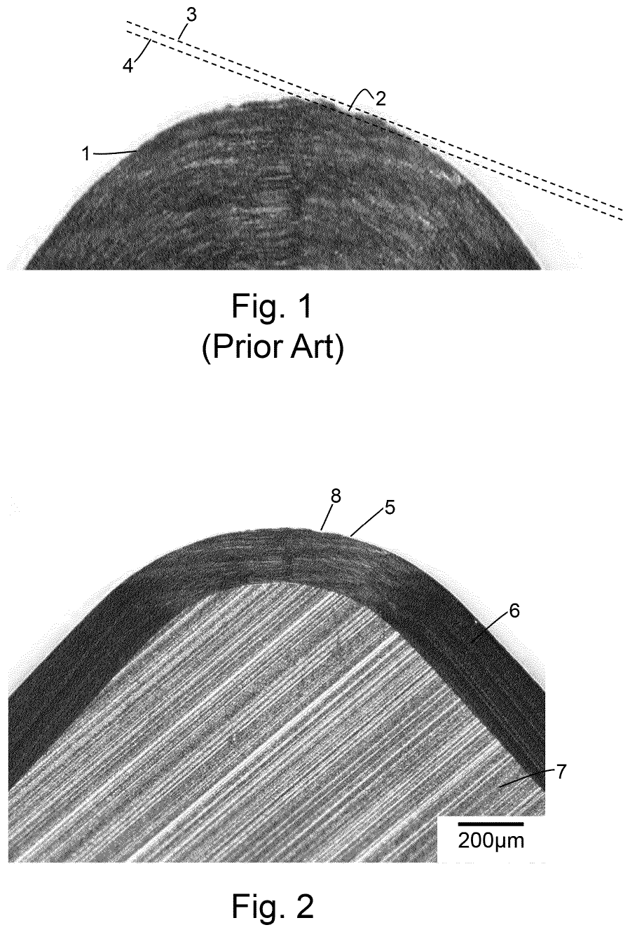

A measurement and quantification method for edge chipping of tool inserts with a curved edge portion has been established and demonstrated. A key advantage of the method described above is that it takes around 30 seconds per image, compared to using an electron microscope to obtain the image and then quantifying individual chips by manually applying tangents, as shown in FIG. 1, which can take up to 30 minutes per image and obtain much less data.

The method has been described as a way of measure incidences of edge chipping during a grinding operation. However, it will be appreciated that it may be used to look at any surface features, such as chipping during tool operation, defects in the tool edge and so on to elucidate correlations between tool edge finish and tool performance or workpiece properties.

The method may be used for any type of cutting tool, including tools used for cutting rocks or other formations.

The skilled person will appreciate that the code may be modified for other applications or geometries across different application areas. The method can also be used as a step to elucidate more fundamental influences of the material behaviour. A Fourier analysis of the edge trace/chips may reveal frequencies related to processing conditions (e.g. grinding speed) or material properties (e.g. grain size).

While this invention has been particularly shown and described with reference to embodiments, it will be understood by those skilled in the art that various changes in form and detail may be made without departing from the scope of the invention as defined by the appended claims. For example, although the examples use cBN as the superhard phase, it will be appreciated that the same techniques may be used for other types of material.

1. A method of characterizing a cutting tool edge, the method comprising:
obtaining an image of the cutting tool edge;
in the image, locating the cutting tool edge;
determining a centre-point of the cutting tool edge; and
at a plurality of angles from the centre-point, characterizing the cutting tool edge by determining the distance from the centre point to the located cutting tool edge.

2. The method according to claim 1, wherein the cutting tool edge is located in the image by any of thresholding the image and applying a Canny edge detection algorithm.

3. The method according to claim 1 or 2, wherein determining the centre-point of the cutting tool edge comprises determining a centre-point of a radius of curvature of a curved portion of the cutting tool edge.

4. The method according to claim 3, wherein the curved portion is substantially circular.

5. The method according to claims 1 or 2, further comprising:
(i) identifying first and second linear portions of the cutting tool edge located either side of the curved portion of the cutting tool edge;
(ii) determining the angle of each of the first and second linear portions relative to a y direction in the image;
(iii) if the angles of the first and second linear portions are not equivalent, rotating the image; and
(iv) repeating steps (ii) and (iii) until the angles of the first and second linear portion are equivalent.

6. The method according to claim 5, further comprising determining the centre-point of the radius of curvature of the curved portion of the cutting tool edge by:
extrapolating the linear portions until they intersect to determine a centre line on which the centre point is located, and
interpolating a parabola in a region around the cutting tool edge to determine the cutting tool radius of curvature.

7. The method according to claims 1 or 2, further comprising:
calculating the difference between the distance from the centre point to the located cutting tool edge and the distance from the centre point to the curved portion of the cutting tool edge determined by the radius of curvature.

8. The method according to claim 7, further comprising plotting the calculated difference against the angle relative to a central axis.

9. The method according to claims 1 or 2, further comprising applying at least one correction to the position of the located cutting tool edge to correct for any of a chamfer angle and a jig angle.

10. The method according to claims 1 or 2, further comprising obtaining the image of the cutting tool edge using any of an optical microscope, a scanning electron microscope, and a focus stacking imaging technique.

11. The method according to claims 1 or 2, wherein the cutting tool comprises any of polycrystalline cubic boron nitride, polycrystalline diamond, cemented tungsten carbide, tool steel, single crystal diamond, diamond grains and cubic boron nitride grains.

12. A computer apparatus configured to perform characterization of a cutting tool edge, the computer apparatus comprising:
an image input device arranged to obtain an image of the cutting tool edge;
a processor configured to locate the cutting tool edge in image;
the processor further configured to determine a centre-point of the cutting tool edge; and
the processor further configured to, at a plurality of angles from the centre-point, characterize the cutting tool edge by determining the distance from the centre point to the located cutting tool edge.

13. The computer apparatus according to claim 12, wherein the processor is configured to locate the cutting tool edge by any of thresholding the image, and applying a Canny edge detection algorithm.

14. The computer apparatus according to claim 12 or claim 13, wherein the processor is configured to determine the centre-point of the cutting tool edge by determining a centre-point of a radius of curvature of a curved portion of the cutting tool edge.

15. The computer apparatus according to claim 12, wherein the processor is further configured to:
(i) identify first and second linear portions of the cutting tool edge located either side of the curved portion of the cutting tool edge;
(ii) determine the angle of each of the first and second linear portions relative to a y direction in the image;
(iii) if the angles of the first and second linear portions are not equivalent, rotate the image; and
(iv) repeat steps (ii) and (iii) until the angles of the first and second linear portion are equivalent.

16. The computer apparatus according to claim 15, wherein the processor is further arranged to determine the centre-point of the radius of curvature of the curved portion of the cutting tool edge by:
extrapolating the linear portions until they intersect to determine a centre line on which the centre point is located, and
interpolating a parabola in a region around the cutting tool edge to determine the cutting tool radius of curvature.

17. The computer apparatus according to claims 12 or 13, wherein the processor is further configured to calculate the difference between the distance from the centre point to the located cutting tool edge and the distance from the centre point to the curved portion of the cutting tool edge determine by the radius of curvature.

18. The computer apparatus according to claim 17, wherein the processor is further configured to plot the calculated difference against the angle relative to a central axis, the computer apparatus further comprising and output device configured to output the plot.

19. The computer apparatus according to claims 12 or 13, wherein the processor is further configured to apply at least one correction to the position of the located cutting tool edge to correct for any of a chamfer angle and a jig angle.

20. A computer program comprising computer readable code which, when run on a computer apparatus, causes the computer apparatus to perform the method as claimed in claims 1 or 2.

21. (canceled)
